(19) United States
(12) Patent Application Publication
(10) Pub. No.: US 2011/0192174 A1
(43) Pub. Date: Aug. 11, 2011

(54) METHOD FOR REGASIFYING LIQUEFIED NATURAL GAS WITH PREVIOUSLY DEHUMIDIFIED AMBIENT AIR

(75) Inventors: Herveline Robidou, Carquefou (FR); Nicolas Bariteau, Nantes (FR)

(73) Assignee: GEA BATIGNOLLES TECHNOLOGIES THERMIQUES, Nantes (FR)

(21) Appl. No.: 13/123,413

(22) PCT Filed: Oct. 5, 2009
(86) PCT No.: PCT/FR2009/051892

§ 371 Date: Apr. 8, 2011

(30) Foreign Application Priority Data
Oct. 10, 2008 (FR) 0856887

(51) Int. Cl. F17C 7/04

(52) U.S. Cl. 62/48.1

(57) ABSTRACT

The method of vaporizing LNG consists in using previously dehumidified ambient air as a direct heat exchange fluid in a first air heat exchanger (5) for heating said LNG to a certain temperature. The dehumidification of the ambient air consists in reducing the temperature of the air in a second air heat exchanger (4) by direct heat exchange with said LNG previously heated in said first heat exchanger (5) at least to said certain temperature, said certain temperature lying approximately in the range −10° C. to −25° C.

The invention relates to a method of heating a fluid, in particular a cryogenic fluid such as liquefied natural gas (LNG). The invention relates more particularly to a method of vaporizing LNG, wherein previously dehumidified ambient air is used as a direct heat exchange fluid in a first air heat exchanger for heating said LNG to a certain temperature.

The invention applies more particularly to a method designed to be implemented in terminals for vaporizing or for re-gasifying LNG, in which terminals the LNG arrives via methane tanker ships in liquid form at a temperature of about −160 degrees Celsius (° C.) and at a pressure of about 1 bar.

At a vaporization terminal, the LNG is pumped in order to increase its pressure to about 90 bars so that the LNG is in a liquid supercritical form at about −160° C. and 90 bars. The LNG is then heated in a vaporization heat exchanger up to a temperature of about +2° C. so as to vaporize it, i.e. so as to transform it into natural gas (NG). The natural gas is then transported via gas pipelines to its place of use.

A very widespread method of vaporizing LNG is the method of Submerged Combustion Vaporizer (SCV) systems that use a fraction of the natural gas as a source of combustion for heating and vaporizing the LNG. For example, Patent Document US 2005/0092263 discloses a vaporization method that consists in causing the LNG to flow through a tube heat exchanger immersed in a pool filled with water and in burning a fraction of the natural gas (up to 1.5% of the production in the most extreme situations) in order to heat the water of the pool so as to heat the LNG and so as to vaporize it. The drawback with that method is that natural gas combustion discharges harmful and polluting products constituted by nitrogen oxides (NOₓ), carbon monoxide (CO), and carbon dioxide (CO₂), and that the cost of using it is high.

Another method of vaporizing LNG that does not suffer from that drawback is known, in particular from U.S. Pat. No. 7,155,917. In that method, the LNG is heated in a first heat exchanger so as to vaporize it by using an intermediate fluid in liquid form that is conveyed by means of a pump in a closed-loop circuit. The intermediate fluid that is cooled in that step is then heated again in a second heat exchanger by ambient air. The drawback with that method is that the air is cooled to such an extent in the second heat exchanger that the water contained in the air condenses on the heat exchanger in the form of frost or ice that is undesirable, in particular because of its thermally insulating nature.

In order to avoid complete interruption of the vaporization, it is known, e.g. from U.S. Pat. No. 5,390,500, that it is possible to use a plurality of vaporization heat exchangers operating in alternation, so that, while one heat exchanger is active (i.e. is serving to vaporize natural gas), one or more other heat exchangers are being defrosted. Unfortunately, that type of vaporizer system is redundant and costly because it uses ambient air of humidity that is not controlled and because a large amount of frost is formed.

Patent Document JP-2005344790 discloses a method of vaporizing LNG in a heat exchanger using ambient air as a heat exchange fluid for heating the natural gas. That method consists in dehumidifying the air upstream from the heat exchanger in an electric dehumidifier, thereby making it possible to reduce the formation of frost on the walls of the heat exchanger. Unfortunately, compared with a method without dehumidification, the electrical power necessary for implementing such a method is multiplied by about 5. That method also considerably increases the head loss on the air side, thereby requiring a substantial increase in the motor drive of the fan system.

Patent Document FR 2 524 623 also discloses a method for cooling ambient air to a very low temperature by using liquid nitrogen. During that method, the liquid nitrogen is heated by the ambient air that has previously been dehumidified.

Patent Document DE 10052856 also discloses a storage container for cryogenic fluid, in particular liquid hydrogen, in which container dehumidified ambient air is used to heat cryogenic fluid.

An object of the invention is to propose a method of heating a fluid, in which previously dehumidified ambient air is used as a direct heat exchange fluid for heating the fluid in a heat exchanger, and in which frost or ice formation on the walls of the heat exchanger is prevented or limited, in a manner that is simple and inexpensive.

Another object of the invention is to propose a method and a system for vaporizing a liquefied cryogenic fluid, in particular LNG, in which previously dehumidified ambient air is used as a direct heat exchange fluid for heating the liquefied cryogenic fluid and for vaporizing it, and in which frost or ice formation on the walls of the heat exchanger serving to vaporize the cryogenic fluid is prevented or limited, in a manner that is simple and inexpensive.

To this end, the invention provides a method of vaporizing LNG, in which previously dehumidified ambient air is used as a direct heat exchange fluid in a first air heat exchanger for heating said LNG to a certain temperature, said method being characterized in that the dehumidification of the ambient air consists in reducing the temperature of the air in a second air heat exchanger by direct heat exchange with said LNG previously heated in said first heat exchanger at least to said certain temperature, said certain temperature lying approximately in the range −10° C. to −25° C.

With this method, a fraction of the water contained in the ambient air is thus condensed on the second heat exchanger by a natural process that is very effective, that is inexpensive, and that is simple to implement. With the method of the invention, it is possible to heat a cryogenic fluid, in particular LNG from a temperature of about −160° C. to about +2° C., without any harmful or polluting discharge into the atmosphere.

The invention also provides a system specially designed to implement such a method of vaporizing a cryogenic fluid, and comprising a first air heat exchanger for heating said LNG to a certain temperature by direct heat exchange with previously dehumidified ambient air, said system being characterized in that it further comprises a second air heat exchanger connected to the first air heat exchanger in series firstly through a circuit of said LNG that conveys said LNG as heated to said certain temperature from an outlet of the first heat exchanger to an inlet of the second heat exchanger, and secondly through an air duct that conveys the dehumidified air exiting from the second heat exchanger to an air inlet of the first heat exchanger, a first fan being disposed above the first air heat exchanger so as to draw air upwards through the first air heat exchanger and a second fan being disposed above the second air heat exchanger so as to blow air downwards through the second air heat exchanger.

The system of the invention may have the following features:
the system comprises at least two parallel first air heat exchangers connected in series to said second air heat exchanger through said fluid circuit and said air duct, and valves are provided in said air duct and in said fluid circuit, which valves are caused to operate by a control unit so as to cause said fluid to flow selectively between the second heat exchanger and one and the other of the first heat exchangers in alternation so as to perform a defrosting cycle in one and the other of the first heat exchangers in alternation;
said air duct is arranged so as to convey the cooled air exiting from a first heat exchanger to an air inlet of the second heat exchanger, and another valve is provided in said air duct for the purpose of regulating the mixture between the ambient air and the cooled air arriving at the inlet of the second heat exchanger so as always to have identical air properties (temperature and humidity, in particular) at the outlet of the second heat exchanger and thus at the inlet of the first heat exchanger; this makes it possible to cause the vaporizer system to operate over defrosting and frosting cycle times that are always identical and thus independent of ambient conditions;
the valves in the air duct are designed like slatted shutters;
each first air heat exchanger has superposed horizontal tubes through which said fluid flows with tubes at the top of the heat exchanger that are provided with external fins and with tubes at the bottom of the heat exchanger that are not provided with external fins, said horizontal tubes further being provided with inside surfaces in relief and/or being double-walled tubes;
the second heat exchanger has superposed horizontal tubes through which said fluid flows, which tubes are provided with external fins and/or are double-walled tubes; and
the fluid flows through a first heat exchanger in counter-flow relative to the flow of air passing through said first exchanger, and said fluid flows through said second heat exchanger in parallel flow relative to the flow of air passing through said second heat exchanger.

Other characteristics and advantages of the method of the invention for vaporizing a cryogenic fluid appear on reading the following description of an embodiment shown in the accompanying drawings, in which:

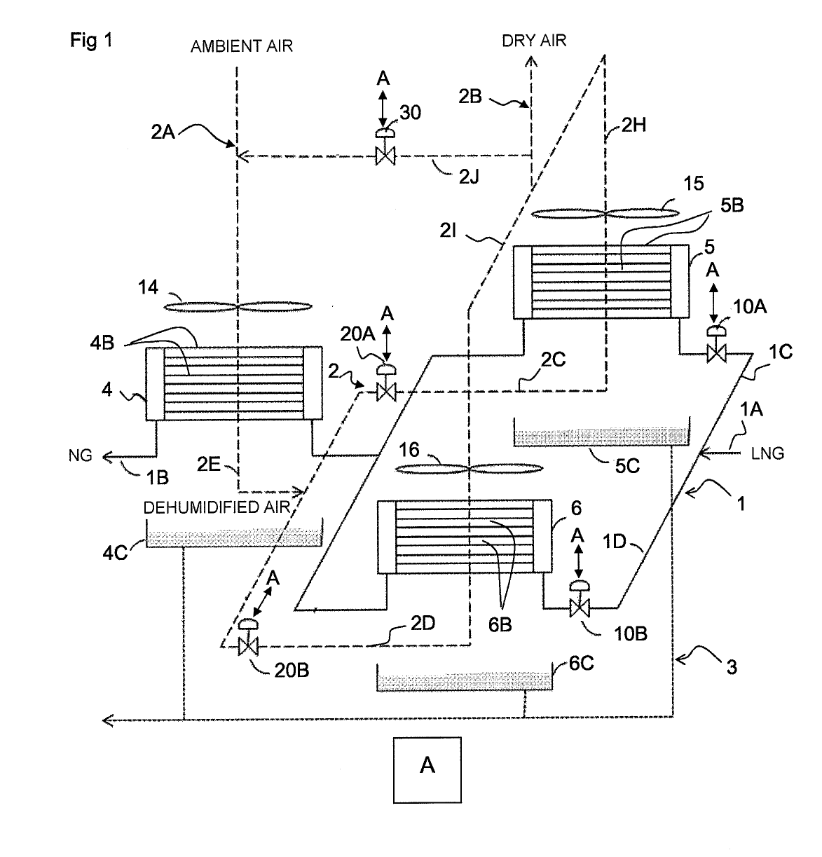

FIG. 1 is a diagram showing the principle of the vaporizer system of the invention;

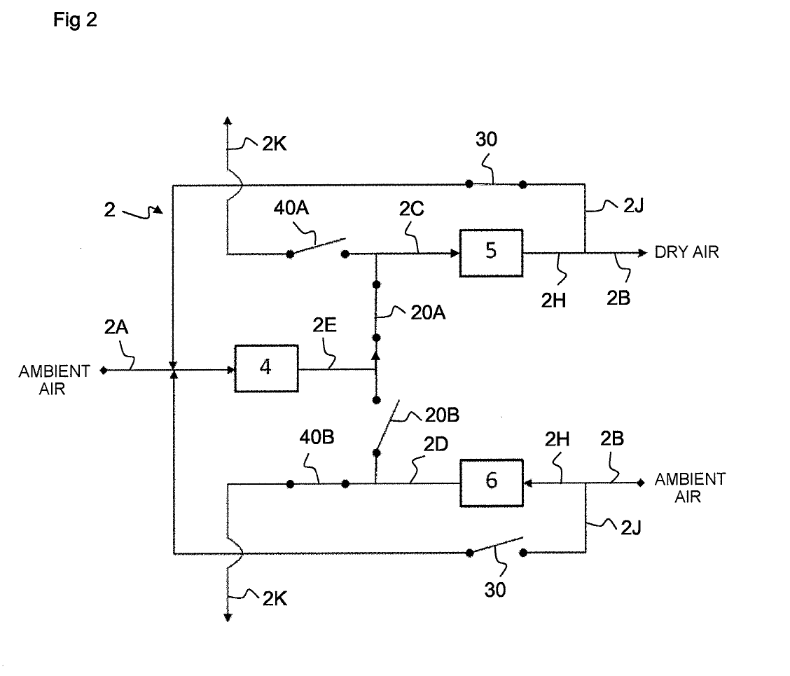

FIG. 2 is a diagram showing the air circuit of the vaporizer system of the invention;

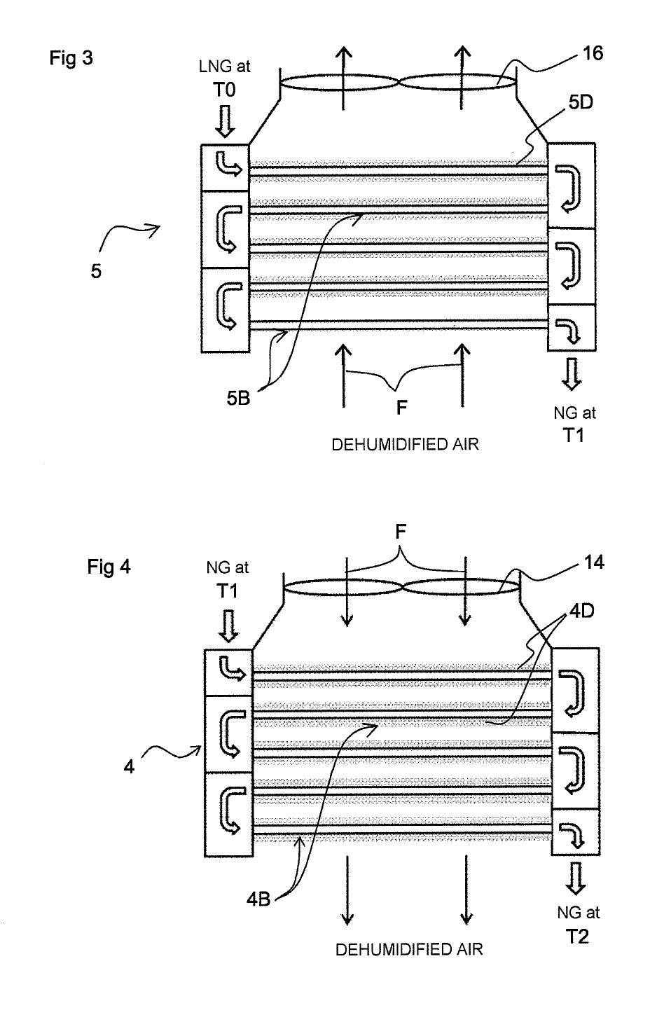

FIG. 3 is a diagrammatic section view through a heat exchanger for vaporizing cryogenic fluid using air; and

FIG. 4 is a diagrammatic section view through a heat exchanger for dehumidifying air using cryogenic fluid.

FIG. 1 is a diagram showing an example of a system of the invention for vaporizing LNG. Naturally, the system of the invention may be used for heating or vaporizing some other cryogenic fluid or refrigerant fluid.

The system comprises a closed circuit 1 for natural gas in the form of cryogenic liquid at the inlet 1A and in the form of gas at the outlet 1B, both of which forms of natural gas are under high pressure (circuit 1 shown in continuous lines), an open circuit 2 for air channeled in the form of a flow of humid ambient air at the inlet 2A and in the form of dry air at the outlet 2B (circuit 2 shown in dashed lines), and an open circuit 3 for water in liquid form coming from the dehumidification of the air and/or from defrosting the air heat exchangers (circuit 3 shown in dashed lines).

In the method of the invention, ambient air, which is used as a direct heat exchange fluid for heating and vaporizing the LNG that arrives at 1A at a temperature T0 of about −160° C. and at a pressure of about 90 bars is previously dehumidified through an air heat exchanger 4 that is connected in series, via the gas closed circuit 1, to two other air heat exchangers 5 and 6, in each of which vaporization of the LNG takes place.

The flow of ambient air that arrives from the outside at the inlet 2A of the air open circuit 2 is blown downwards by a fan 14 through the heat exchanger 4 and is cooled to a temperature of +5° C. by the effect of heat exchange with the vaporized natural gas that enters the heat exchanger 4 at a temperature T1 of about −15° C. This cooling of the ambient air causes it to be dehumidified and thus the air that exits via the bottom of the heat exchanger 4 has relative humidity of about 100%. Such dehumidification makes it possible to extract from the ambient air an absolute quantity of water that is large if it is considered that the ambient air arrives at 2A at a temperature of 10° C. and with humidity that varies depending on the climate and on the season of the place in which the vaporizer system is installed. At the same time, the vaporized natural gas is heated to a temperature T2 of about +2° C. by heat exchange with ambient air in the heat exchanger 4. The temperatures (between T1 and T2) of the natural gas in the heat exchanger 4 are chosen to be sufficiently high to maintain a positive temperature on the outside surface of the heat exchanger 4, and thus not to generate frost on the outside surface of the heat exchanger 4. It is possible to provide a heat exchanger 4 disposed horizontally with tubes 4B having external fins arranged to drain the condensed water coming from the cooled air. The drops of water from condensation of the cooled air are collected in a retention tray 4C connected to the water open circuit 3.

This portion of the vaporizer system thus serves to dehumidify the ambient air by natural cooling with the advantage that this cooling also serves the main function of vaporizing LNG without excessive consumption of energy.

The air circuit 2 includes an appropriate duct represented by 2C, 2D, 2E for feeding the heat exchangers 5 and 6 with dehumidified air exiting from the heat exchanger 4. In each of the heat exchangers 5 and 6, the supercritical natural gas is heated by direct heat exchange, from a temperature T0 of −160° C. to a temperature T1 lying in the range −10° C. to −25° C., preferably to about −15° C., by the dehumidified air that arrives at about 5° C. in the heat exchanger 5, 6. This heat exchange cools the air passing through the heat exchangers 5 and 6 to a considerable extent, this air going from 5° C. and 100% humidity at the inlets of the heat exchangers to about −25° C. and 0% humidity at the outlets of the heat exchangers 5, 6 and therefore at the outlets 2B of the air circuit 2.

In order to improve the effectiveness of the heat exchange in the heat exchangers 5 and 6, the circulation of the flow of air by the fans 15, 16 is forced, said fans increasing the flow of air drawn (towards the top of the heat exchanger) through the heat exchangers and countering the overall static head loss of the air circuit 2. In this portion of the system shown in FIG. 1, the air thus flows upwards so as to pass through the heat exchangers 5 and 6 that are disposed horizontally. It is also possible to make provision to blow the air downwards through the heat exchanger by the fans 15, 16.

If ambient air is available at a sufficient temperature and/or with sufficient humidity at the inlet 2A, the vaporizer system of the invention can operate continuously with a single vaporization heat exchanger such as 5 and the dehumidification heat exchanger 4 without the presence of frost on the walls. In order to facilitate heat exchange in the heat exchanger 5, the heat exchanger tubes 5B through which the LNG flows are provided with external fins, but in order to prevent the presence of frost, it is possible to make provision for such external fins to be omitted from the tubes at the bottom of the heat exchanger.

If frost still appears on the surfaces of the tubes 5B, 6B of the heat exchangers 5 and 6, provision is made to have the two heat exchangers operate respectively and alternately in “vaporizing” mode and in “deicing” or “defrosting” mode. As shown in FIG. 1, the two heat exchangers 5 and 6 are connected in parallel to the inlet 1A of the natural gas circuit by two gas ducts 1C and 1D, each of which is provided with a regulator valve 10A, 10B actuated by an electronic control unit A. In addition, each of the segments 2C and 2D of the air duct that are interposed between the air outlet of the heat exchanger 4 and each air inlet of the heat exchangers 5 and 6 is provided with a regulator valve 20A and 20B actuated by the control unit A. The vaporizer system of the invention is preferably entirely covered, and the valves 20A, 20B regulating the air flow can be designed like slatted shutters that are caused to open and to close by the control unit A.

FIG. 2 shows the air circuit 2 when the heat exchanger 5 is in vaporizing mode and when the heat exchanger 6 is in defrosting mode. In vaporizing mode for vaporizing the liquefied gas in the heat exchanger 5, the control unit A closes the valves 10A and 20B (in FIG. 2, the valve 20B is shown as an “open” switch), and leaves the valves 10A and 20A open (in FIG. 2, valve 20A is shown as a “closed” switch), so as to direct the flow of air from the dehumidification heat exchanger 4 to the vaporization heat exchanger 5 (as indicated by the arrows in FIG. 2). The heat exchanger 6 is then in defrosting mode because it passes neither the LNG nor the flow of cooled air. Conversely, when the valves 10A and 20A) are closed by the control unit A while the valves 10B and 20B are open, the heat exchanger 6 is in vaporizing mode for vaporizing the LNG while the heat exchanger 5 is in defrosting mode for defrosting using ambient air.

It can thus be understood that the air circuit (shown more clearly in FIG. 2) is arranged so that the dehumidified air exiting from the heat exchanger 4 is directed via two separate ducts 2C, 2D towards the heat exchanger 5 and towards the heat exchanger 6. These ducts can be sheet-metal ducts that are closed respectively onto the bottoms of the heat exchangers 4, 5, and 6. The flow rate of air in the air circuit 2 depends on the heat exchange surface area available in the heat exchanger, and can, for example, lie in the range 1000 metric tonnes per hour (t/h) to 2000 t/h; the flow rate of LNG can be about 160 t/h.

As can be seen in FIG. 1, water retention trays 5C and 6C are provided under respective ones of the heat exchangers 5 and 6 so as so to collect the water from deicing. The retention trays are connected to the water circuit 3 so as to enable the collected water to be removed.

In order to adjust the vaporizing and defrosting cycle times better in the heat exchangers 5 and 6, it is important to have an identical and constant quantity of water in the dehumidified air arriving at the heat exchangers 5 and 6. For this purpose, it is possible to set the temperature of the ambient air arriving at the inlet of the heat exchanger 4, for example, to a constant temperature of about 10° C., by mixing it in controlled manner with the cooled air exiting from the heat exchangers 5 and 6. For this purpose, as shown in FIGS. 1 and 2 by the references 2H, 2I, and 2J, additional ducts are provided in the air circuit 2 so as to deflect a fraction of the flow of air exiting from each heat exchanger 5 or 6 towards the inlet of the heat exchanger 4, which fraction of the flow of air is metered by means of a valve 30 (or of slatted shutters) actuated by the control unit A.

In order to optimize the defrosting of the heat exchanger 5 or 6, the ambient air serving for the defrosting can be blown by reversing the direction of rotation of the fans 15, 16, making it possible for the air to flow downwards, or by natural convection. As shown in FIG. 2, and additional duct 2K provided with a valve 40A, 40B (or with slatted shutters) controlled by the control unit A makes it possible to remove the ambient air, the valve 40A being open when the heat exchanger 5 is in defrosting mode and closed when the heat exchanger is in vaporizing mode. It is also possible to add an air heater unit (not shown) disposed either above the heat exchanger 5, 6 when the air flows downwards, or below the heat exchanger 5, 6 when the air flows upwards, in order to accelerate the defrosting stage. All of the closed additional ducts 2H, 2I, 2J, and 2K of the air circuit 2 can also be made of sheet metal.

The heat exchangers 5 and 6 being caused to operate in alternation makes it possible not to interrupt operation of the vaporizer system even in the presence of frost. As a function of the cycle time related to the defrosting (which time is related to the temperature of the outside ambient air), the vaporizer system of the invention can include two heat exchangers such as 4 for dehumidification that serve three vaporization heat exchangers such as 5 and 6, two exchangers out of the three for vaporizing the gas always operating at the same time in vaporizing mode, while the third one is operating in defrosting mode. The vaporizer system can also include three dehumidification heat exchangers that serve four heat exchangers for vaporizing the gas, three out of the four vaporization heat exchangers always operating at the same time in vaporizing mode, while the fourth one is operating in defrosting mode. It is thus possible to have a vaporizer system operating with a heat exchanger such as 4 delivering dehumidified air to a plurality of heat exchangers in parallel such as 5 and 6.

FIG. 3 shows an example of an air heat exchanger such as 5 serving, in accordance with the invention, to vaporize LNG and operating, in this example, in counter-flow relative to the flow of air, as is known per se in the art. The direction of the flow of dehumidified air drawn upwards by means of the fan 15 is indicated by arrows F. The LNG is injected at the top of the heat exchanger 5, at a temperature T0 of about −160° C., into tubes 5B made of nickel-enriched steel and grouped together in a horizontal bank of tubes, and exits at the bottom of the heat exchanger 5 in gaseous form at a temperature T1 of about −15° C. The tubes 5B can be arranged to contain a plurality of circulation passes of the LNG so as to improve the effectiveness of the heat exchange.

In this heat exchanger 5, the tubes 5B at the top of the heat exchanger are provided with circular external fins 5D that are made of aluminum and that serve to increase the heat exchange surface area and thus to improve the heat exchanges between the air and the natural gas. It is possible, on the contrary, for the tubes 5B that are situated at the bottom of the heat exchanger relative to the direction of the flow of air not to be provided with external fins, thereby limiting formation of frost. All of the tubes 5B can be provided with inside surfaces in relief (not shown) having internal fins or internal structures (and referred to as “structured surfaces”) in order to improve the heat exchange between the natural gas and the walls of the tubes. The tubes 5B can thus be double-walled tubes (not shown), each having an annular portion around an inner tube, the natural gas in liquid form flowing through the inner tube and the vaporized natural gas (in gaseous form) flowing through the annular portion. This makes it possible to limit appearance of highly negative temperatures at the surfaces of the external fins 5D, thereby limiting propagation of the frost and limiting the thermal stresses between the tube 5B and the external fins 5D.

FIG. 4 shows an example of an air heat exchanger such as 4 serving for dehumidifying ambient air. It comprises a bank of tubes 4B made of nickel-enriched steel and grouped together in a horizontal bank. In this example, the tubes 4B are provided with external fins 4D made of aluminum and serving to facilitate heat exchange and also to improve drainage of the condensation water. This heat exchanger 4 can be arranged to operate in parallel flow, as is known per se in the art. The natural gas in gaseous form (NG) is injected at the top of the heat exchanger 4, at a temperature T1 of about −15° C. and it exits via the bottom of the heat exchanger 4 at a temperature T2 of about +2° C. As indicated by arrow F in FIG. 4, the flow of air is blown by the fan 14 downwards towards the bottom of the heat exchanger. The heat exchanger 4 operating in parallel flow enables the temperature of the walls of the tubes of the heat exchanger 4 to be kept positive at all times, even though the thermal effectiveness of the heat exchanger 4 is then slightly lower compared with a heat exchanger operating in counter-flow. The tubes 4B can be double-walled tubes in order to keep the temperature of the walls of the tubes positive, and thus to prevent frost from forming on the walls, for natural gas temperatures T1 of less than −15° C., and down to −25° C.

The vaporizer system of the invention can be coupled to a vaporizer system of a type different from the above-described SCV, in order to reduce the operating cost. For example, it is possible to cause a vaporizer system of the SCV type to operate during the coldest 8 months of the year (when the temperature of the ambient air is less than 10° C.) and to cause a vaporizer system of the invention to operate for the remaining 4 months of the year. It is thus possible to reduce the annual operating costs by more than 25% compared with a system of the SCV type operating for all 12 months of the year.

1. A method of vaporizing LNG, in which previously dehumidified ambient air is used as a direct heat exchange fluid in a first air heat exchanger (5) for heating said LNG to a certain temperature (T1), said method being characterized in that the dehumidification of the ambient air consists in reducing the temperature of the air in a second air heat exchanger (4) by direct heat exchange with said LNG previously heated in said first heat exchanger (5) at least to said certain temperature (T1), said certain temperature (T1) lying approximately in the range −10° C. to −25° C.

2. A system for vaporizing LNG, comprising a first air heat exchanger (5) for heating said LNG to a certain temperature (T1) by direct heat exchange with previously dehumidified ambient air, said system being characterized in that it further comprises a second air heat exchanger (4) connected to the first air heat exchanger (5) in series firstly through a circuit (1) of said LNG that conveys said LNG as heated to said certain temperature (T1) from an outlet of the first heat exchanger (5) to an inlet of the second heat exchanger (4), and secondly through an air duct (2) that conveys the dehumidified air exiting from the second heat exchanger (4) to an air inlet of the first heat exchanger (5), a first fan (15) being disposed above the first air heat exchanger (5) so as to draw air upwards through the first air heat exchanger (5) and a second fan (14) being disposed above the second air heat exchanger (4) so as to blow air downwards through the second air heat exchanger (4).

3. A system according to claim 2, comprising at least two parallel first air heat exchangers (5; 6) connected in series to said second air heat exchanger (4) through said fluid circuit (1) and said air duct (2), and wherein valves (10A, 10B, 20A, 20B) are provided in said air duct (2) and in said fluid circuit (1), which valves are caused to operate by a control unit (A) so as to cause said fluid to flow selectively between the second heat exchanger (4) and one and the other of the first heat exchangers (5; 6) in alternation so as to perform a defrosting cycle in one and the other of said first heat exchangers in alternation.

4. A system according to claim 2, wherein said air duct (2) is arranged so as to convey the cooled air exiting from a first heat exchanger (5; 6) to an air inlet of the second heat exchanger (4), and wherein another valve (30) is provided in said air duct (2) for the purpose of regulating the mixture between the ambient air and the cooled air arriving at the inlet of the second heat exchanger (4).

5. A system according to claim 2, wherein the valves (20A, 20B, 30, 40A, 40B) in the air duct (2) are designed like slatted shutters.

6. A system according to claim 2, wherein each first air heat exchanger (5; 6) has superposed horizontal tubes (5B, 6B) through which said fluid flows with tubes at the top of the heat exchanger (5; 6) that are provided with external fins (5D) and with tubes at the bottom of the heat exchanger (5; 6) that are not provided with external fins, said horizontal tubes (5B, 6B) further being provided with inside surfaces in relief and/or being double-walled tubes.

7. A system according to claim 2, wherein the second heat exchanger (4) has superposed horizontal tubes (4B) through which said fluid flows, which tubes are provided with external fins and/or are double-walled tubes.

8. A system according to, wherein said fluid flows through a first heat exchanger (5; 6) in counter-flow relative to the flow of air passing through said first exchanger (5; 6), and wherein said fluid flows through said second heat exchanger (4) in parallel flow relative to the flow of air passing through said second heat exchanger (4).
